(19) United States
(12) Patent Application Publication
(10) Pub. No.: US 2014/0190532 A1
(43) Pub. Date: Jul. 10, 2014

(54) NOZZLE CLEANING DEVICE AND COATER PROVIDED WITH IT

(71) Applicants: Yueyan Zhang, Shenzhen (CN); Wende Huang, Shenzhen (CN); Houyi Zhu, Shenzhen (CN)

(72) Inventors: Yueyan Zhang, Shenzhen (CN); Wende Huang, Shenzhen (CN); Houyi Zhu, Shenzhen (CN)

(73) Assignee: Shenzhen China Star Optoelectronics Technology Co., Ltd., Shenzhen, Guangdong (CN)

(21) Appl. No.: 13/824,420

(22) PCT Filed: Jan. 25, 2013
(86) PCT No.: PCT/CN2013/070980

§ 371 Date: Mar. 18, 2013

(30) Foreign Application Priority Data
Jan. 10, 2013 (CN) 201310008969.9

(51) Int. Cl. B05B 1/18; B08B 9/027

(52) U.S. Cl. CPC B05B 1/185; B08B 9/027
USPC 134/166 C; 239/106

(57) ABSTRACT

A nozzle cleaning device and a coater provided with the nozzle cleaning device are provided, the nozzle cleaning device comprise a cleaner, a vacuum pipe and a vacuum pump; the cleaner has a recessed hole coinciding in shape with the nozzle of the coater for receiving the nozzle of the coater, and the inner wall of the recessed hole is provided with a plurality of through-holes; one end of the vacuum pipe is connected to said a plurality of through-holes, and the other end of the vacuum pipe is connected to the vacuum pump. The nozzle cleaning device of the present invention can be used conveniently to remove the photoresist residue so as to clean the nozzle, which effectively improves the product yield and the production efficiency, and reduces the cost due to needing no expensive nanomaterials.

### FIELD OF THE INVENTION

The present invention relates to a coater in an optical process, particularly to a nozzle cleaning device for a coater and a coater provided with it.

### BACKGROUND OF THE INVENTION

There is a widespread gelatin problem with a photoresist coating platform used in the display manufacturing process. That is, after the photoresist coating is completed, there is frequently partially solidified photoresist residue left at the tip and surroundings of the nozzle. When the nozzle is used next time for coating, the photoresist residue may obstruct the channel through which the photoresist is sprayed, which may affect the quality of the subsequently processed products. Therefore, in the prior art, before each glass plate is coated with photoresist, a cleaner made of rubber is usually used to wipe the photoresist residue off the tip of the nozzle. However, due to the great elasticity of the rubber itself, the cleaner is often unable to closely fit with the nozzle, and thus it is difficult to clean the tip of the nozzle effectively. Besides, with most of the rubber materials have very poor absorbency, it is difficult to adsorb and remove photoresist when the nozzle is wiped with rubber, making the photoresist wiped away still remain at the tip of the nozzle, causing the nozzle to be dirtier.

For the above problem, another commonly used solution is to coat the inner portion and surroundings of the nozzle with a film made of particular nanomaterials, so as to increase the lubricity of the tip of the nozzle, prevent retention and accumulation of the photoresist material in the vicinity of the nozzle, and thereby keep the nozzle clean. But this method needs to use expensive nanomaterials and has a high cost.

### CONTENTS OF THE INVENTION

The object of the present invention is to provide a nozzle cleaning device that can suck the photoresist residue off the tip and surroundings of the nozzle through vacuuming as well as a coater provided with the nozzle cleaning device, so as to overcome the defect that the rubber cleaner cannot clean the nozzle of the coater completely in the prior art.

A nozzle cleaning device is provided, comprising a cleaner, a vacuum pipe and a vacuum pump; the cleaner has a recessed hole coinciding in shape with the nozzle of the coater for receiving the nozzle of the coater, and the inner wall of the recessed hole is provided with a plurality of through-holes; one end of the vacuum pipe is connected to said a plurality of through-holes, and the other end of the vacuum pipe is connected to the vacuum pump.

In the nozzle cleaning device, the through-holes are arranged at the bottom of the inner wall of the recessed hole.

In the nozzle cleaning device, the through-holes are also arranged at both sides of the inner wall of the recessed hole.

In the nozzle cleaning device, the cleaner is made of rubber material.

A coater is also provided, comprising:

a coating liquid output device filled with coating liquid, including a nozzle through which the coating liquid is sprayed;

a nozzle cleaning device including a cleaner, a vacuum pipe and a vacuum pump, the cleaner has a recessed hole coinciding in shape with the nozzle of the coater for receiving the nozzle of the coater, the inner wall of the recessed hole is provided with a plurality of through-holes; one end of the vacuum pipe is connected to said a plurality of through-holes, and the other end of the vacuum pipe is connected to the vacuum pump; and

a transmission device connected to the bottom of the cleaning device, operable to controlling the movement of the cleaning device and providing a driving force to make the cleaning device up and down.

In the coater, the cleaning device includes a base, to which the transmission device is connected for supporting the cleaning device.

In the coater, the length of the cleaner is it as that of the nozzle.

In the coater, the through-holes are arranged at the bottom of the inner wall of the recessed hole.

In the coater, the through-holes at the bottom of the recessed hole are offset with respect to the internal pipe of the nozzle of the coater.

In the coater, the through-holes are also arranged at both sides of the inner wall of the recessed hole.

A coater is provided, comprising:

a coating liquid output device filled with coating liquid, including a nozzle through which the coating liquid is sprayed; and

a nozzle cleaning device including a cleaner, a vacuum pipe, a vacuum pump, and a movable base; the cleaner is mounted on the base and it has a recessed hole coinciding in shape with the nozzle of the coater for receiving the nozzle of the coater, the inner wall of the recessed hole is provided with a plurality of through-holes; one end of the vacuum pipe is connected to said a plurality of through-holes, and the other end of the vacuum pipe is connected to the vacuum pump

In the coater, the length of the cleaner is it as that of the nozzle.

In the coater, the through-holes are arranged at the bottom of the inner wall of the recessed hole.

In the coater, the through-holes at the bottom of the recessed hole are offset with respect to the internal pipe of the nozzle of the coater.

In the coater, the through-holes are also arranged at both sides of the inner wall of the recessed hole.

Through the nozzle cleaning device and a coater provided with it according to the present invention, the following beneficial effects can be obtained: The rubber cleaner is additionally provided with a plurality of through-holes which are connected to the vacuum pump through the vacuum pipe; the photoresist residue at the tip and surroundings of the nozzle is sucked into the vacuum pipe by vacuuming, thus getting the nozzle of the coater cleaned. The nozzle cleaning device of the present invention can be used conveniently to remove the photoresist residue so as to clean the nozzle, which effectively improves the product yield and the production efficiency, and reduces the cost due to needing no expensive nanomaterials.

### BRIEF DESCRIPTION OF THE DRAWINGS

The nozzle cleaning device and the coater provided with it according to the present invention will be explained further with reference to appending drawings and embodiments. In the drawings:

FIG. 1 is a schematic diagram of the coater provided with the nozzle cleaning device according to a preferred embodiment of the present invention;

FIG. 2 is a front view of the nozzle cleaning device according to a preferred embodiment of the present invention; and

FIG. 3 is a side view of the nozzle cleaning device according to a preferred embodiment of the present invention.

### DETAILED DESCRIPTION OF THE EMBODIMENTS

A nozzle cleaning device and a coater provided with it are provided to thoroughly remove the photoresist residue around the nozzle of the coater, thereby solving the corresponding product quality problem and improving the product yield. The nozzle cleaning device of the coater in the present invention is preferably used for cleaning the photoresist coating platform in the preceding process of the thin film transistor liquid crystal display (TFT-LCD) process; in different embodiments, it can also be applied to the high precision processes such as a semiconductor process or the like, or other processes that need prevention of gel formation.

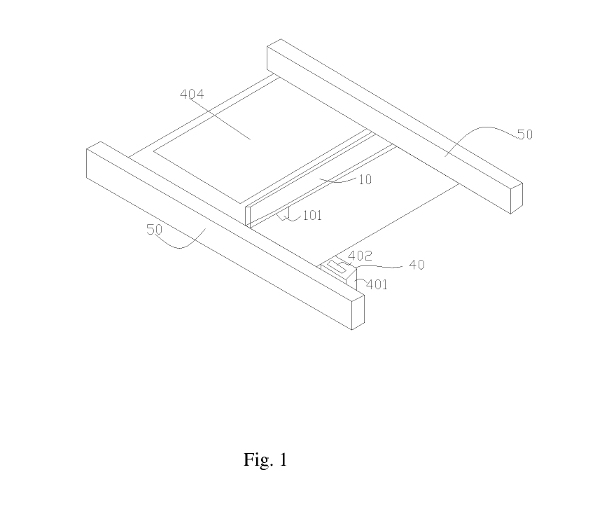

FIG. 1 shows a coater provided with the nozzle cleaning device according to a preferred embodiment of the present invention. The coater includes a coating liquid output device 10, a transmission device (the transmission device in FIG. 1 is not shown for being covered), a cleaning device 40, and a pair of guide rails 50. The coating liquid output device 10 includes a nozzle 101, through which the filled coating liquid can be exported. The transmission device may be a device that can output power to drive the cleaning device to rise, such as an automatic control motor, a semi-automatic control motor, and a step motor currently available. The coating liquid output device 10 connected to a pair of guide rails 50, can move back and forth by sliding on the guide rail 50. The cleaning device 40 is located below the origin of the movement of the coating liquid output device 10, and aligned with the nozzle 101 of the coating liquid output device 10. The cleaning device 40 includes a base 401, a cleaner 402, a vacuum pipe 403 (the vacuum pipe in FIG. 1 is not shown for being covered), and a vacuum pump 404. The base 401 connected to the transmission device 20 can move under the power provided by the transmission device 20. When the nozzle 101 of the coating liquid output device 10 returns to the origin, the driving force provided by the transmission device 20 drives the cleaning device 40 to rise to fit with the nozzle 101, that is, the tip of the nozzle 101 butts against the cleaner 402 of the cleaning device 40. The cleaner 402 of the cleaning device 40 is connected to the vacuum pump 404 through the vacuum pipe 403, thereby forming a vacuum loop.

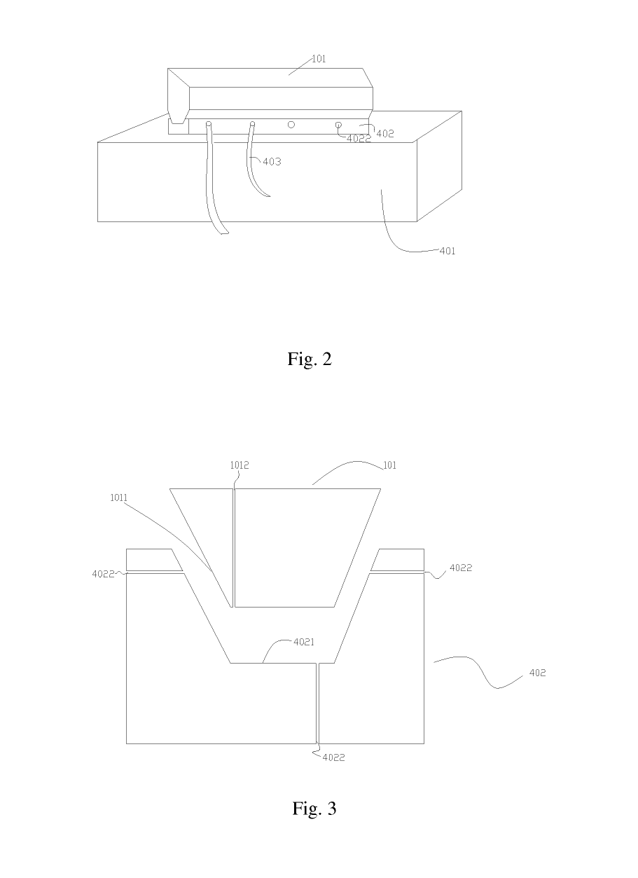

Referring to FIG. 2 and FIG. 3, they have showed the schematic diagram of the nozzle cleaning device according to the preferred embodiment of the present invention. FIG. 2 is a front view of the cleaning device, while FIG. 3 a side view of the cleaning device. Wherein the nozzle 101 of the coater is drawn to be a see-through element; however, its actual structure is unlimited to this. The vacuum pump 404 in the diagram is not shown for being covered. In this embodiment, the nozzle 101 of the coating liquid output device 10 of the coater has a nozzle face 1011, and is provided inside with an internal pipe 1012. The cleaning device 40 includes a cleaner 402, a base 401, a vacuum pipe 403 and a vacuum pump 404.

In the preferred embodiment shown in FIG. 2 and FIG. 3, the cleaner 402 is fixedly mounted on the base 401, and the connection between them can be through screw, adhesive or hinge. The base 401 can be made of plastic or metal. The length of the cleaner 402 is it as that of the nozzle 101 of the coater, i.e. it as that of the short side of the glass substrate; when the nozzle 101 is cleaned with the cleaner 402, there is no need to travel along the distance of the length of the short side of the glass substrate, thus reducing the cleaning time. The cleaner 402 has a recessed hole 4021, which coincides in shape with the nozzle face 1011 of the nozzle 101; the nozzle 101 of the coater is received in the recessed hole 4021, both closely fitting with each other. The recessed hole 4021 is provided with a row of through-holes 4022 at the bottom of the inner wall, and can further be provided with a row of through-holes 4022 at both sides and the bottom of the inner wall at it time. The through-holes 4022 are preferably circular or square, and can also be of any other shape, or of arbitrary permutation and combination of different shapes. The through-holes 4022 at the bottom are offset with respect to the internal pipe 1012 in the nozzle 101; that is, when the nozzle 101 fits with the cleaner 402, the through-holes 4022 at the bottom will not be aligned or communicated with the internal pipe 1012, which can prevent the coating liquid in the internal pipe 1012 of the nozzle 101 from being sucked together into the vacuum pipe when vacuuming, thereby avoiding wasting the coating liquid. Each of the through-holes 4022 is in airtight connection with a corresponding vacuum pipe 403, which is connected at the other end to the vacuum pump 404. During cleaning, the control valve of the vacuum pump is opened, and the solidified coating liquid at the tip and surroundings of the nozzle 101 received in the recessed hole 402 is sucked out through the vacuum pipe 403. In this preferred embodiment, the coating liquid is photoresist or such coating liquids as a sealant; the cleaner 40 may be made of rubber materials, plastics or other petrochemical materials; the vacuum pipe 403 may be made of stainless steel.

As shown in FIG. 1 to FIG. 3, when the nozzle 101 of the coating liquid output device 10 of the coater moves to the origin, the transmission device 20 provides a driving force to push the cleaning device 40 connected thereto to rise. The cleaner 402 of the cleaning device 40 rises to the recessed hole 4021 of the cleaner 402 to completely fit with the nozzle face 1011 of the nozzle 101. The vacuum pump 404 opens the control valve, and vacuums the sealed space formed by fitting of the vacuum pipe 403 with the recessed hole 4021 and the nozzle face 1011. With the powerful attraction due to vacuuming, the coating liquid at the tip and surroundings of the nozzle 101 is sucked into the vacuum pipe 403, thereby effectively cleaning the nozzle 101. The residual coating liquid inside the vacuum pipe 403 is discharged to the outside of the coater under the action of air pressure.

It should be understood that those skilled in the art can make improvement or transformation according to the above contents, which shall all fall within the scope of protection of the claims of the present invention.

1. A nozzle cleaning device comprising a cleaner, a vacuum pipe and a vacuum pump; the cleaner has a recessed hole coinciding in shape with the nozzle of the coater for receiving the nozzle of the coater, and the inner wall of the recessed hole is provided with a plurality of through-holes; one end of the vacuum pipe is connected to said a plurality of through-holes, and the other end of the vacuum pipe is connected to the vacuum pump.

2. The nozzle cleaning device of claim 1, wherein, the through-holes are arranged at the bottom of the inner wall of the recessed hole.

3. The nozzle cleaning device of claim 2, wherein, the through-holes are also arranged at both sides of the inner wall of the recessed hole.

4. The nozzle cleaning device of claim 1, wherein, the cleaner is made of rubber material.

5. A coater comprising:
a coating liquid output device filled with coating liquid, including a nozzle through which the coating liquid is sprayed;
a nozzle cleaning device including a cleaner, a vacuum pipe and a vacuum pump, the cleaner has a recessed hole coinciding in shape with the nozzle of the coater for receiving the nozzle of the coater, the inner wall of the recessed hole is provided with a plurality of through-holes; one end of the vacuum pipe is connected to said a plurality of through-holes, and the other end of the vacuum pipe is connected to the vacuum pump; and
a transmission device connected to the bottom of the cleaning device, operable to controlling the movement of the cleaning device and providing a driving force to make the cleaning device up and down.

6. The coater of claim 5, wherein, the cleaning device includes a base, to which the transmission device is connected for supporting the cleaning device.

7. The coater of claim 5, wherein, the length of the cleaner is it as that of the nozzle.

8. The coater of claim 5, wherein, the through-holes are arranged at the bottom of the inner wall of the recessed hole.

9. The coater of claim 8, wherein, the through-holes at the bottom of the recessed hole are offset with respect to the internal pipe of the nozzle of the coater.

10. The coater of claim 8, wherein, the through-holes are also arranged at both sides of the inner wall of the recessed hole.

11. A coater comprising:
a coating liquid output device filled with coating liquid, including a nozzle through which the coating liquid is sprayed; and
a nozzle cleaning device including a cleaner, a vacuum pipe, a vacuum pump, and a movable base; the cleaner is mounted on the base and it has a recessed hole coinciding in shape with the nozzle of the coater for receiving the nozzle of the coater, the inner wall of the recessed hole is provided with a plurality of through-holes; one end of the vacuum pipe is connected to said a plurality of through-holes, and the other end of the vacuum pipe is connected to the vacuum pump

12. The coater of claim 11, wherein, the length of the cleaner is it as that of the nozzle.

13. The coater of claim 11, wherein, the through-holes are arranged at the bottom of the inner wall of the recessed hole.

14. The coater of claim 13, wherein, the through-holes at the bottom of the recessed hole are offset with respect to the internal pipe of the nozzle of the coater.

15. The coater of claim 13, wherein, the through-holes are also arranged at both sides of the inner wall of the recessed hole.
